(19) United States
(12) Patent Application Publication
(10) Pub. No.: US 2009/0256480 A1
(43) Pub. Date: Oct. 15, 2009

(54) LAMP AND LIQUID CRYSTAL DISPLAY HAVING THE SAME

(75) Inventors: Hyun-Jin KIM, Yongin-si (KR); Seok-Hyun NAM, Seoul (KR); Kyung-Min KIM, Asan-si (KR); So-Jin RYU, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, (KR)

(21) Appl. No.: 12/417,085

(22) Filed: Apr. 2, 2009

(30) Foreign Application Priority Data
Apr. 11, 2008 (KR) 10-2008-0033754

(51) Int. Cl. H01J 17/18

(52) U.S. Cl. 313/624

(57) ABSTRACT

A lamp and a liquid crystal display including the lamp, the lamp including a lamp tube into which a discharge gas is injected, an internal electrode portion disposed at each of a first end and a second end at an inner side of the lamp tube, an electrode lead connected to each of the internal electrode portions and extending to an exterior side of the lamp tube, and a transparent cap disposed on outer surface of each of the first end and the second end of the lamp tube.

This application claims priority to Korean Patent Application No. 10-2008-0033754 filed on Apr. 11, 2008, and all the benefits accruing therefrom under 35 U.S.C. §119, the disclosure of which is incorporated herein by reference in its entirety.

### BACKGROUND OF THE INVENTION

1. Field of the Invention

The present invention relates to a lamp and a liquid crystal display having the same, and more particularly, to a lamp having long life span by improving a temperature distribution structure, and a liquid crystal display including the lamp.

2. Description of the Related Art

Flat panel displays, such as liquid crystal displays (“LCDs”) or plasma display panels (“PDPs”), are spotlighted as next generation displays in place of cathode ray tubes (“CRTs”). Among the flat panel displays, the LCD does not emit light by itself. The LCD requires a backlight unit for providing light for displaying images at its rear surface, so as to allow the displayed images to be visually perceived.

As a light source of the backlight unit, a cold cathode fluorescent lamp (“CCFL”), an external electrode fluorescent lamp (“EEFL”), and the like, are generally used. An internal space of such a lamp is filled with a discharge gas containing a rare gas such as neon (Ne), or argon (Ar) with a small amount of mercury (Hg) added thereto. The rare gas such as neon (Ne), or argon (Ar) exists in a gas state at room temperature while mercury (Hg) predominantly exists in a liquid state and only a trivial amount of mercury (Hg) exists in a gas state at room temperature.

Movement of the mercury ions inside the lamp is chiefly made by vaporization. Here, the internal vapor pressure of the lamp affecting the vaporization considerably depends upon ambient temperatures. In order to control unevenness of the mercury distribution, an internal temperature distribution across a lamp must be taken into consideration. If the coldest points exist at a particular area inside a lamp, the vaporization of mercury at the particular area is suppressed and condensation of mercury is facilitated.

The conventional lamp includes a lamp tube into which a discharge gas is injected, and an electrode portion which is connected to both sides of the lamp tube. The lamp tube includes external surfaces around opposite ends of the lamp which are inserted into mounting members, for example, lamp holders, or lamp sockets, to then be mounted to a product.

### BRIEF SUMMARY OF THE INVENTION

Since the LCD requires a backlight unit to provide light for displaying images, a lamp including an internal spaced filled with a discharge gas may be employed in the backlight unit. As neon (Ne) or argon (Ar) discharge gas, which mostly exists in a gas state, is relatively free moving, the mercury (Hg) discharge gas, which mostly exists in a liquid state, moves in a relatively limited manner, and may be unevenly distributed within the lamp. Further, if the vaporization of mercury at the particular area is suppressed and condensation of mercury is facilitated, so that the vaporized mercury ions gather, mercury ions are distributed unevenly due to accumulation of the vaporized mercury ions. As the discharge gas across a lamp may be unevenly distributed within the lamp, undesirable dark regions may be generated in the lamp.

Additionally, since the lamp may include a lamp tube having external surfaces around opposite ends of the lamp which are inserted into mounting members, the mounting member may act as an unintended cooling means to form the coldest points at opposite ends of the lamp, generating lamp degradation over time. For example, as the opposite ends of the lamp are overheated by the mounting member, the coldest points are formed at the external region of the electrode portions provided at either end of the lamp. The coldest points are formed at local areas, and mercury (Hg) gathers thereat. Since the external region of the electrode portion is isolated from the exterior, the gathered mercury (Hg) cannot move, which means the gathered mercury (Hg) is substantially ineffective mercury (Hg) that cannot participate in a light emission process. Accordingly, effective mercury (Hg) present in the discharge tube is used up over time, resulting in lamp degradation.

An exemplary embodiment of the present invention provides a lamp reducing or effectively eliminating lamp degradation by solving the problem of mercury gathering occurring at opposite ends of the lamp even after prolonged use, a liquid crystal display including the lamp.

An exemplary embodiment of the present invention also provides a lamp exhibiting uniformity in emission characteristics over the entire effective emissive area by solving the problem of generation of dark regions occurring at a particular region inside the lamp.

In an exemplary embodiment, there is provided a lamp including a lamp tube into which a discharge gas is injected, an internal electrode portion disposed at each of opposite ends of inner sides of the lamp tube, an electrode lead connected to each of the internal electrode portions and extending to an exterior side of the lamp tube, and a transparent cap disposed on outer surfaces and around each of the opposite ends of the lamp tube.

The transparent caps may extend toward the center of the lamp tube, such that ends of the transparent caps are disposed beyond inner ends of the internal electrode portions toward a center of the lamp tube.

The transparent caps may extend to overlap an area of the lamp tube having a substantially uniform temperature distribution at an internal region of the internal electrode portions, the internal region of the internal electrode portions being a portion of the lamp tube between a point substantially corresponding to the inner ends of the internal electrode portions, and extending to a predetermined distance from the inner ends of the internal electrode portions.

The transparent caps may extend about 40 millimeters (mm) from a distal end of the lamp tube.

The transparent caps may include a material containing transparent polymer.

The transparent polymer may include at least one of vinyl, polyethylene terephthalate (PET), and polyvinyl chloride (PVC).

The discharge gas may include mercury.

An ultraviolet (UV) radiation blocking layer may be disposed on at least one of internal walls of the lamp tube, a body of the lamp tube, and outer walls of the lamp tube.

The UV radiation blocking layer may include titanium oxide.

The ultraviolet (UV) radiation blocking layer may be disposed between the lamp tube and the transparent caps, both the ultraviolet (UV) radiation blocking layer and the transparent caps extending from a distal end of the lamp tube and ending at a predetermined distance from the distal end, and ends of the ultraviolet (UV) radiation blocking layer and the transparent caps substantially coincide with each other.

In an exemplary embodiment, there is provided a liquid crystal display (“LCD”) including an LCD panel displaying images, and a backlight unit including at least one lamp providing light to the LCD panel. The at least one lamp includes a lamp tube into which a discharge gas is injected, the lamp tube including a first distal end and a second distal end opposite to the first distal end, an internal electrode portion disposed at each of the first distal end and the second distal end, and disposed at an inner side of the lamp tube, an electrode lead connected to each of the internal electrode portions and extending to an exterior side of the lamp tube, and a transparent cap disposed on an outer surface of each of the first distal end and the second distal end of the lamp tube.

The transparent caps may extend toward the center of the lamp tube from a respective distal end, and ends of the transparent caps are disposed beyond inner ends of the internal electrode portions.

The ends of the transparent caps may be disposed overlapping an area of the lamp having a substantially uniform temperature distribution at the internal region of the internal electrode portions, the internal region of the electrode portions being disposed beyond the inner ends of the internal electrode portions.

An UV radiation blocking layer may be formed on at least one of internal walls of the lamp tube, a body of the lamp tube, and outer walls of the lamp tube.

The UV radiation blocking layer may be made of titanium oxide.

The LCD may further include a mounting member fixing the lamp.

The transparent caps may include a material having lower thermal conductivity than the mounting member.

The lamp may be installed on either a lateral surface or an entire area of a rear surface of the LCD panel.

An exemplary embodiment of a method of forming a lamp includes disposing an internal electrode portion at an inner area of each of a first end and a second end of a lamp tube, connecting a first end of an electrode lead to each internal electrode portion, and disposing a second end of the electrode lead at an exterior of the lamp tube, and disposing a transparent cap covering an outer surface of each of the first end and the second end of the lamp tube. The transparent cap respectively overlaps the first end and the second end of the lamp tube, and extends a predetermined distance from the first end and the second end of the lamp tube toward a center region of the lamp tube. Ends of the transparent caps are disposed overlapping an area of the lamp tube having a uniform temperature distribution at an internal region of the internal electrode portions, the internal region of the electrode portions being disposed beyond inner ends of the internal electrode portions.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an exemplary embodiment of a lamp according to the present invention;

FIG. 2 is a cross-sectional view of the lamp taken along line A-A′ in FIG. 1;

FIG. 3 is a cross-sectional view illustrating another exemplary embodiment of a lamp according to the present invention;

FIG. 4 is a cross-sectional view illustrating another exemplary embodiment of a lamp according to the present invention;

FIG. 5 is a cross-sectional view illustrating another exemplary embodiment of a lamp according to the present invention;

FIG. 6 graphically illustrates the temperature distribution across a lamp according to Comparative Example 1;

FIG. 7 graphically illustrates the temperature distribution across a lamp according to Comparative Example 2;

FIG. 8 graphically illustrates the temperature distribution across a lamp according to an Example of the present invention;

FIG. 9 is an exploded perspective view of an exemplary embodiment of a liquid crystal display including a lamp according to the present invention; and

FIG. 10 is an exploded perspective view of another exemplary embodiment of a liquid crystal display including a lamp according to the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below,” “lower,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

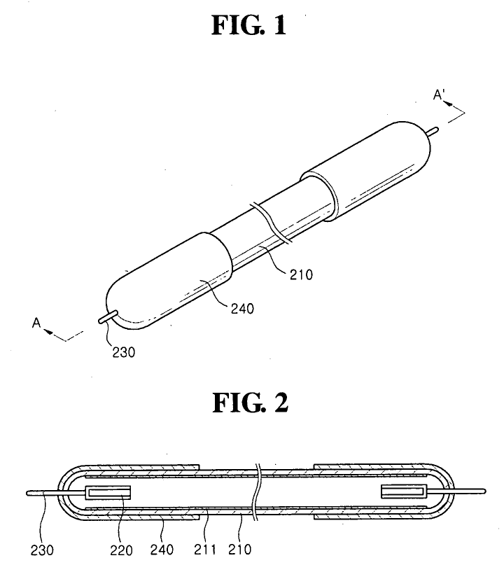

FIG. 1 is a perspective view of an exemplary embodiment of a lamp according to the present invention, and FIG. 2 is a cross-sectional view of the lamp taken along line A-A′ in FIG. 1.

Referring to FIGS. 1 and 2, the lamp includes a lamp tube 210 into which a discharge gas is injected, internal electrode portions 220 which are disposed at opposite ends of inner sides (e.g., at an inside) of the lamp tube 210, electrode leads 230 which are connected to the internal electrode portions 220 at an inside of the lamp and extending to the exterior of the lamp tube 210 (e.g., an outside of the lamp), and transparent caps 240 which are formed on outer surfaces and around both of opposing distal ends of the lamp tube 210.

The lamp tube 210 shown in FIGS. 1 and 2 is shaped of a relatively narrow cylinder, forming an T shape. A discharge gas generating primary light is injected into the lamp tube 210. The discharge gas may include a mixed gas including a rare gas such as argon (Ar), neon (Ne), or xenon (Xe), and a predetermined amount of mercury (Hg). An internal pressure of the lamp may be about 1/10 atmospheric pressure. The discharge gas is not limited to the listed examples, and any of a number of discharge gas may be used as long as it can be effectively used for a fluorescent lamp.

Mercury (Hg) generates primary light, for example, UV radiation, by discharge. As the primary light, mercury (Hg) in the discharge gas generates ultra-violet (UV) radiation when mercury is electrically discharged in the lamp body 210. Argon (Ar), neon (Ne), or xenon (Xe) in the discharge gas is ionized to generate a secondary electron, thereby increasing the amount of the UV radiation. Therefore, a discharge firing voltage is lowered by a penning effect and the power consumption decreases.

In addition, a fluorescent material 211 generating secondary light may be coated on an internal wall of the lamp tube 210. The fluorescent material 211 is preferably formed by appropriately combining three-wavelength type fluorescent lamp materials so as to emit white light, i.e., red, green, and blue fluorescent materials. In an exemplary embodiment, as a red fluorescent material, Y₂O₃:Eu³⁺ can be used, a green fluorescent material, LaPO₄:Ce³⁺, and a blue fluorescent material, BaMg₂Al₁₆O₂₇:Eu³⁺. Of course, combinations with other fluorescent materials may be possible.

The internal electrode portions 220 are disposed at opposite ends of inner sides of the lamp tube 210, and may be disposed completely within the lamp tube 210, such as to be completely surrounded by or enclosed the lamp tube 210. The internal electrode portions 220 may be substantially shaped as a hollow cylinder. Each of the internal electrode portions 220 has a first end which is substantially closed, and a second (e.g., opposing) end opened and disposed to face toward a central portion of the lamp tube 210. A first end of the internal electrode portion 220 may be considered as being disposed adjacent to a respective distal end of the lamp tube 210.

As described above, since each of the internal electrode portions 220 is substantially cylindrical, its surface area is increased, and an amount of electrons emitted increases accordingly, thereby increasing brightness and reducing mercury consumption. Consequently, the life span of the internal electrode portions 220 can be extended. The shapes of the internal electrode portions 220 are not limited and may be formed in various shapes as long as its surface area can be increased. Alternatively, the internal electrode portions 220 can be shaped of a bar or a plate.

Additionally, the internal electrode portions 220 can also be made of various conductive materials. In an exemplary embodiment, the internal electrode portions 220 may be formed of a metal such as nickel (Ni), molybdenum (Mo), or niobium (Nb). Such a metal has a relatively small work function value, allowing discharge with a low driving voltage compared to other metals.

In order to apply lamp driving power to the internal electrode portions 220, a first end of each of the electrode leads 230 is connected to the internal electrode portion 220, and a second end thereof is extended to the exterior of the lamp tube 210 and further connected to an external member (not shown). A bead portion (not shown), which perforates the electrode leads 230, may be disposed substantially at the center of the electrode leads 230, and may be connected to each of opposite ends of the lamp tube 210. Accordingly, the opposite ends of the lamp tube 210 are closely sealed by the bead portion, and the electrode leads 230 are securely fixed through the bead portion. In an exemplary embodiment, where the lamp tube 210 is made of glass, the electrode leads 230 combined with glass bead are inserted into the opposite ends of the lamp tube 210 and then subjected to fusion bonding, thereby closely sealing the opposite ends of the lamp tube 210.

The transparent caps 240 are formed on outer surfaces at the opposite ends of the lamp tube 210. The transparent caps 240 may be shaped substantially in a hollow tube, and then inserted onto the opposite ends of the lamp tube 210. Alternatively, the transparent caps 240 may be directly coated on the outer surface of the lamp tube 210. In the former case, a thermally shrinkable tube may be preferably used as the transparent caps 240.

An area beginning at a point substantially corresponding to a inner end of an internal electrode portion 220, or disposed just beyond or adjacent to the inner end of the internal electrode portion 220 nearer the center of the lamp tube 210, and extending to a predetermined distance from the inner end of the internal electrode portion 220, may be referred to as an “internal region” of the respective internal electrode portion 220. The predetermined distance may be considered to a point to which the transparent caps 240 are extended. Conversely, an area disposed between a distal end of the lamp tube 210 and the internal electrode portion 220, may be referred to as an “external region” of the respective internal electrode portion 220.

The transparent caps 240 extend from a distal end of the lamp tube 210 and toward a center of the lamp tube 210, such that a distal end of the transparent caps 240 are disposed beyond inner ends of the internal electrode portions 220. The transparent caps 240 preferably extend toward the center of the lamp tube 210 so as to be disposed beyond inner ends of the internal electrode portions 220, so that the transparent caps overlap at least a portion of the internal region of the internal electrode portions 220. Advantageously, the transparent caps 240 extend at a sufficient distance to form a substantially uniform temperature distribution at the internal region of the internal electrode portions 220, for example, for about 40 millimeters (mm) of the lamp tube 210 measured from a distal end of the lamp.

The transparent caps 240 are preferably made of light-transparent materials so as to externally extract most of light generated from the lamp tube 210. In an exemplary embodiment, materials for the transparent caps 240 may include transparent polymer such as vinyl, polyethylene terephthalate (PET), polyvinyl chloride (PVC), or the like.

Since the transparent caps 240 are closely adhered to the outer surfaces around the opposite ends of the lamp tube 210 to then be integrated onto the lamp tube 210, airtightness of sealing portions of the lamp can be advantageously ensured. In addition, since minute cracks around the sealing portions of the lamp are filled with materials forming the transparent caps 240, it is possible to prevent sizes of the cracks from increasing. Further, it is possible to reduce or effectively prevent the discharge gas from leaking through the minute cracks.

The transparent caps 240 may be formed by dipping, or the like. In one exemplary embodiment, the opposite ends of the lamp tube 210 having the electrode leads 230 attached thereto, are dipped into a liquid material for forming the transparent caps 240. Coatings formed on outer surfaces of the electrode leads 230 are then removed, thereby forming the transparent caps 240.

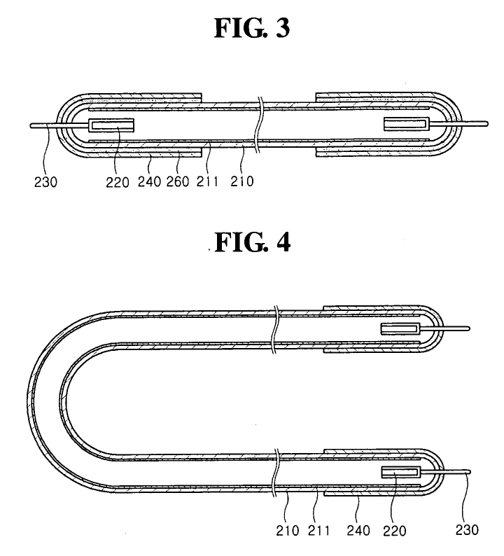

FIG. 3 is a cross-sectional view illustrating another exemplary embodiment of a lamp according to the present invention.

Referring to FIG. 3, the lamp includes an ultraviolet light blocking layer 260 formed on an outer surface of the lamp tube 210, and disposed between an inner surface of the transparent caps 240 and the outer surface of the lamp tube 210. The UV radiation blocking layer 260 extends from and around a distal end of the lamp tube 210, and toward the center of the lamp tube 210. The UV radiation blocking layer 260 may be extended to be longer than or equal to respective extended lengths of the transparent caps 240. The UV radiation blocking layer 260 may be considered as completely overlapped with the transparent caps 240 when inner ends of the UV radiation blocking layer 260 and the transparent caps 240 substantially coincide with each other, as illustrated in FIG. 3.

The UV radiation blocking layer 260 blocks UV radiation emitted from the lamp tube 210, thereby reducing or effectively preventing deterioration of the transparent caps 240. Advantageously, a reduction in brightness can be avoided even after prolonged use of the lamp. Alternatively, the UV radiation blocking layer 260 may be formed on a portion of or an entire of internal walls of the lamp tube 210 and/or a body of the lamp tube 210, as well as on outer walls of the lamp tube 210. Further, the UV radiation blocking layer 260 may be formed to cover an entire of an inner and/or outer surface of the lamp tube 210.

During the operation of a lamp, UV radiation is emitted. The UV radiation may deteriorate the transparent caps 240, causing damages thereto. In particular, the transparent caps 240 partially extend toward and overlap the internal region of the internal electrode portions 220 to infiltrate a portion of an effective emissive area of the lamp. In an exemplary embodiment, the UV radiation layer 260 may be disposed in substantially an entire of the emissive area of the lamp.

If the transparent caps 240 turn yellow as due to the deteriorated transparent caps 240 according to the UV radiation, the transmittance characteristic becomes poor and the brightness of the lamp is reduced. Accordingly, the lamp shown in FIG. 3 can reduce or effectively prevent deterioration of the transparent caps 240 by forming the UV radiation blocking layer 260 blocking the UV radiation emitted from the lamp tube 210 on the outer surface of the lamp tube 210. A yellow tint of the transparent caps 240 may be caused by UV radiations in a wavelength range of about 310 nanometers (nm) to about 320 nanometers (nm). Thus, the UV radiation blocking layer 260 is preferably made of a material demonstrating a high UV radiation blocking effect in the wavelength range, e.g., titanium oxide (TiO₃).

In exemplary embodiments, the lamp may have any of a number of various shapes. Hereinafter, another exemplary embodiment of a lamp according to the present invention will be described. Here, the same explanations as the previous embodiment will not be made or will be briefly made.

FIG. 4 is a cross-sectional view illustrating another exemplary embodiment of a lamp according to the present invention.

Referring to FIG. 4, the lamp includes a lamp tube 210 into which a discharge gas is injected, internal electrode portions 220 which are disposed at opposite ends at an internal portion of the lamp tube 210, electrode leads 230 which are connected to the internal electrode portions 220 at the internal of the lamp tube 210 and extended to an exterior of the lamp tube 210, and transparent caps 240 which are formed on outer surfaces and completely around the opposite ends of the lamp tube 210.

As discussed above, an area beginning at a point proximate to a inner end of an internal electrode portion 220, or disposed just beyond or adjacent to the inner end of the internal electrode portion 220 nearer the center of the lamp tube 210, and extending to a predetermined distance from the inner end of the internal electrode portion 220, may be referred to as an “internal region” of the respective internal electrode portion 220. The predetermined distance may be considered to a point to which the transparent caps 240 and/or the UV radiation blocking layer 260 are extended. Conversely, an area disposed between a distal end of the lamp tube 210 and the internal electrode portion 220, may be referred to as an “external region” of the respective internal electrode portion 220.

The transparent caps 240 preferably extend from a distal end of the lamp tube 210 and toward a central portion of the lamp tube 210, so as to be disposed beyond inner ends of the internal electrode portions 220. Extension ends (e.g., distal ends) of the transparent caps 240 may extend toward the internal region of the internal electrode portions 220 disposed at internal sides of the lamp tube 210. More preferably, the transparent caps 240 extend to an area of the lamp having at least a uniform temperature distribution at the internal region of the internal electrode portions 220.

Unlike the lamp illustrated in FIGS. 1-3, the lamp tube 210 shown in FIG. 4 may have a centrally bent shape, forming an overall ‘U’ shape. Alternatively, the lamp tube 210 may have various bent shapes, for example, an L-shape, a V-shape, a W-shape, or an M-shape.

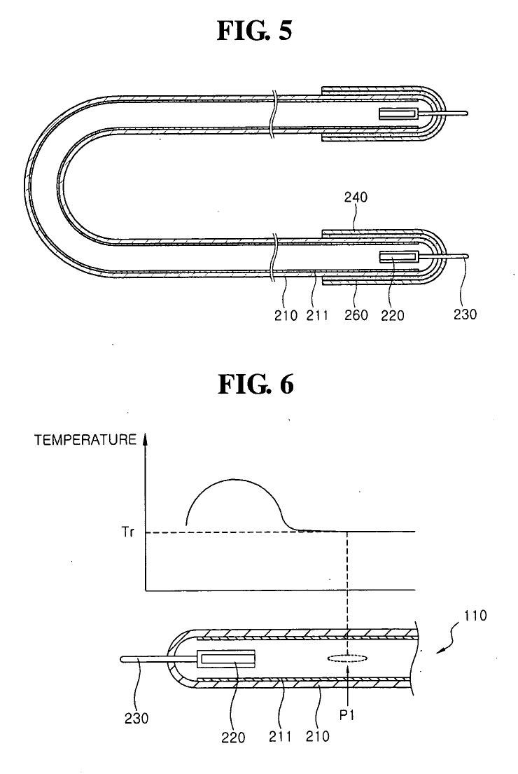

FIG. 5 is a cross-sectional view illustrating another exemplary embodiment of a lamp according to the present invention.

Referring to FIG. 5, the lamp includes an UV radiation blocking layer 260 formed on an outer surface of the lamp tube 210. The UV radiation blocking layer 260 is disposed between the transparent caps 240 and the lamp tube 210, such that the transparent caps 240 completely overlap the UV radiation blocking layer 260. The UV radiation blocking layer 260 extends from a distal end of and toward the center of the lamp tube 210, to be disposed further than or equal to extended lengths of the transparent caps 240. The distal ends of the lamp tube 210 may be considered as completely covered by the UV radiation blocking layer 260 and the transparent caps 240. The UV radiation blocking layer 260 blocks UV radiation emitted from the lamp tube 210, thereby reducing or effectively preventing deterioration of the transparent caps 240. Advantageously, a reduction in brightness can be avoided even after prolonged use of the lamp.

Next, a light emission process of the lamps illustrated in the embodiments of FIGS. 1-4 will be described. Initially, external lamp driving power is applied from an outside of the lamp to the internal electrode portions 220 of the lamp, through the electrode leads 230. When the lamp driving power is applied to the internal electrode portions 220, electrons are emitted from the internal electrode portions 220, and the emitted electrons collide with discharge gas present within the lamp tube 210, e.g., mercury (Hg). The discharge gas is ionized by electron collision, thereby creating a plasma environment inside the lamp tube 210. Here, light having a predetermined first wavelength, for example, UV radiation, is generated. The fluorescent material 211 formed on the inner surface of the lamp tube 210 is excited by the UV radiation to generate light having a predetermined second wavelength, for example, white light.

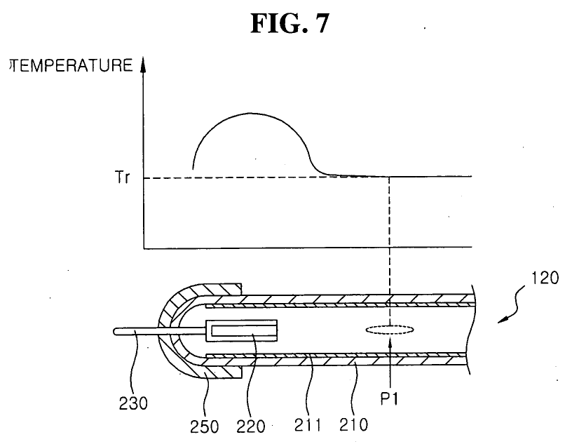

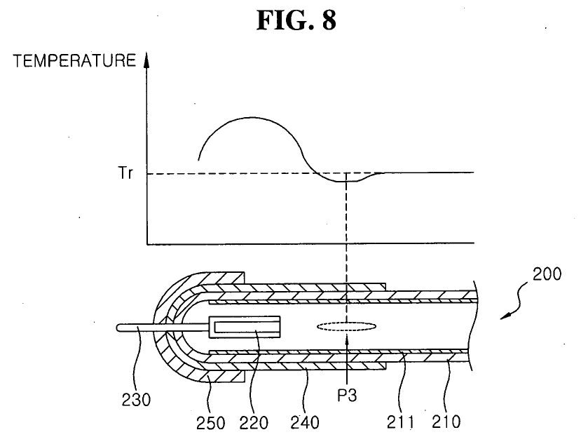

FIG. 6 graphically illustrates a temperature distribution across a lamp according to Comparative Example 1, FIG. 7 graphically illustrates a temperature distribution across a lamp according to Comparative Example 2, and FIG. 8 graphically illustrates a temperature distribution across a lamp according to an exemplary embodiment of the present invention.

Lamps are generally mounted on mounting members, e.g., lamp holders or lamp sockets. In order to demonstrate operating characteristics of lamps used in practice, FIGS. 7 and 8 show lamp holders 250 are mounted on opposite ends of the lamp.

Referring to FIG. 6, in a single-line arrangement, since the internal electrode portions 220 generate heat, the lamp 110 demonstrates a temperature (Tr) distribution. The temperature distribution includes a relatively sharp temperature rise at an end (e.g., distal) area of the lamp tube 210, a maximum temperature level at an area of the lamp 110 corresponding to internal electrode portions 220, a relatively sharp temperature drop after passing the area of the internal electrode portions 220 (e.g., past inner ends of the internal electrode portion 220), and a minimum temperature level at a central area of the lamp tube 210, to finally reach a substantially uniform temperature distribution of the lamp 110.

With this temperature distribution structure, the relatively coldest points P1 of the lamp 110 are formed at the central area of the lamp tube 210, and mercury (Hg) may gather thereat. However, since the central area of the lamp tube 210 has an open area at opposing ends of the central area, the gathered mercury (Hg) may migrate for vaporization. Advantageously, even after even after prolonged use, lamp degradation due to exhaustion of effective mercury (Hg) can be reduced or effectively avoided.

On the other hand, referring to FIG. 7, in a lamp 120 mounted on a lamp holder 250, the lamp holder 250 functions as heat dissipation means, resulting in overcooling. Thus, the lamp tube 210 demonstrates a relatively lower temperature at both end areas of the lamp 120 than at a central area of the lamp 120. With this temperature distribution structure, the coldest points P2 are formed at an external region of the internal electrode portions 220, that is, between the end areas of the lamp tube 210 and the internal electrode portions 220. Here, the coldest points P2 are formed at local areas, and mercury (Hg) is heavily distributed at the local areas. However, unlike the internal region of the lamp tube 210 (e.g., at an area past the internal electrode portions 220), the external region of the internal electrode portions 220 is isolated from the internal region of the lamp tube 210, and the mercury (Hg) heavily distributed thereat cannot migrate toward the internal region of the lamp tube 210, such that the mercury (Hg) becomes ineffective. Disadvantageously, effective mercury (Hg) may be used up over time, resulting in lamp degradation.

Referring to FIG. 8, the lamp 200 according to an exemplary embodiment of the present invention includes transparent caps 240 formed on outer surfaces and around distal ends of the lamp tube 210. The lamp tube 210 is mounted on a lamp holder 250. Even if the lamp holder 250 functions as heat dissipation means, both the internal and external regions of the internal electrode portions 220 are cooled by the transparent caps 240, which are configured to cover the internal and external regions of the internal electrode portions 220. Advantageously, like the lamp 110 in a single-line arrangement, as shown in FIG. 6, a relatively lower temperature of the lamp 200 is maintained at the internal region of the internal electrode portions 220 (e.g., to the right of the internal electrode portions in FIG. 8) than at the end area of the lamp tube 210 (e.g., to the left of the internal electrode portions in FIG. 8).

However, since temperatures (Tr) gradually decreases from a temperature distribution range in which a sharp temperature rise at distal ends of the lamp, to a substantially uniform temperature distribution range at a central area of the lamp 200, observation of the coldest points P3 are minimized, or effectively eliminated. Even if the coldest points P3 are observed, the coldest points P3 are observed throughout a relatively wide area, rather than at local areas. Even if gathering of mercury (Hg) occurs, mercury (Hg) is distributed over a relatively wide area. In addition, since the internal region of the internal electrode portions 220, in which the coldest points P3 are observed, is an opened space having opened end areas at opposing sides, such as relative to the central area of the lamp tube 210, the mercury (Hg) gathered thereat may migrate away from the gathering location to other places for vaporization. Advantageously, even after prolonged use, lamp degradation due to exhaustion of effective mercury (Hg) can be reduced or effectively avoided.

The lamps according to the present invention can be used as the light sources of a variety of products. Next, a liquid crystal display (“LCD”) including a lamp used as an edge-type backlight unit according to an exemplary embodiment of the present invention, will be described.

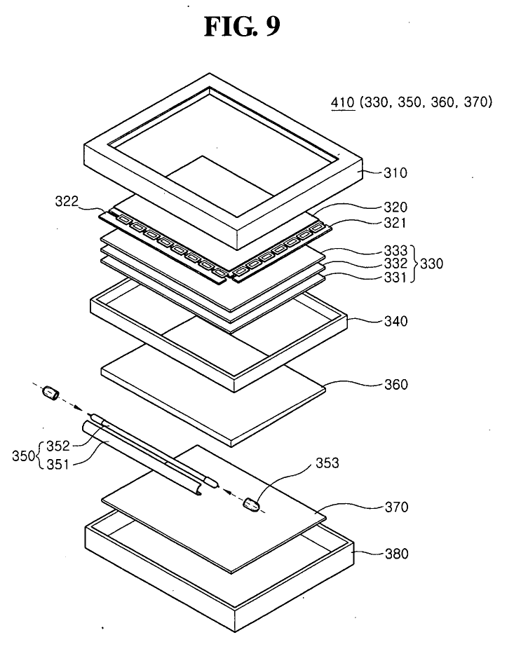

FIG. 9 is a perspective view of an exemplary embodiment of a liquid crystal display including a lamp according to the present invention.

Referring to FIG. 9, the LCD includes an LCD panel 320 displaying images, a backlight unit 410 disposed below the LCD panel 320, and a top chassis 310 and a bottom chassis 380 receiving the LCD panel 320 and the backlight unit 410.

The LCD panel 320 includes a lower substrate including a plurality of gate lines, a plurality of data lines crossing the gate lines, thin film transistors formed at crossing areas of the gate lines and the data lines, pixel electrodes, an upper substrate formed corresponding to the lower substrate and including a common electrode and color filters, and a liquid crystal layer disposed between the upper and lower substrates. The LCD panel 320 displays predetermined images according to an external image signal by controlling the amount of light passing through the liquid crystal layer.

A gate driver 321 for driving the gate lines and a data driver 322 for driving the data lines may be disposed at one substrate of the LCD panel 320, preferably at an external (e.g., peripheral) area of the lower substrate. The gate driver 321 is connected to each of the gate lines of the LCD panel 320 and applies a predetermined gate signal to each gate line. The data driver 322 is connected to each of the data lines of the LCD panel 320 and applies a predetermined data signal to each data line. The gate driver 321 and the data driver 322 may be manufactured in chips and/or may be mounted on the LCD panel 320 by one of a COB (Chip On Board) mounting method, a TAB (Tape Automated Bonding) mounting method, and a COG (Chip On Glass) mounting method. In exemplary embodiments where the resolution of the LCD panel 320 is relatively low, the TAB mounting method is suitably used, and in a case where the resolution of the LCD panel 320 is relatively high, a COG mounting method is suitably used. The chip may be directly mounted on the lower substrate by an ASG (Amorphous Silicon Gate) mounting method.

The backlight unit 410 is disposed at a rear of the LCD panel 320, such as on a side of the LCD panel 320 towards the bottom chassis 380 as illustrated in FIG. 9. The backlight unit 410 includes a lamp unit 350 emitting light, a light guiding plate 360 disposed at a lateral surface of and adjacent to the lamp unit 350, an optical sheet 330 disposed above the light guiding plate 360, such as on a side of the light guiding plate 360 towards the LCD panel 320, and a reflector sheet 370 disposed below the light guiding plate 360. The light supplied from the backlight unit 410 undergoes a change in the transmittance and is colored while passing through the LCD panel 320, and is then emitted to the front surface of the LCD panel 320, thereby implementing a color image. A front surface of the LCD panel 320 may be considered as a light emitting side or a viewing side of the LCD proximate to the LCD panel 320.

The lamp unit 350 includes at least one lamp 352 generating light, and a reflector 351 condensing the light generated from the lamp 352.

An I-shaped lamp according to the exemplary embodiment of FIGS. 1-3 may be used as the lamp 352 in the LCD of FIG. 9. As shown in FIG. 2, the lamp includes transparent caps 240 formed on outer surfaces of and completely around opposite (e.g., distal) ends of the lamp tube 210. The outer surfaces of the opposite ends of the lamp tube 210 are fitted into a lamp holder 353 made of an elastic material, e.g., rubber, to then be securely fixed on inner walls of the reflector 351. The lamp holder 353 may be configured such that the lamp holder 353 covers an entire of an end of the lamp tube 210, such as completely overlapping a respective transparent cap 240 and/or UV radiation blocking layer 260.

The transparent caps 240 preferably extend from a distal end of the lamp 352 toward the center of the lamp tube 210 so as to be disposed beyond inner ends of the internal electrode portions 220. The transparent caps 240 cover at least a portion of the internal region of the internal electrode portions 220.

In exemplary embodiments, the transparent caps 240 are preferably made of a material having lower thermal conductivity than the lamp holder 353. The lamp 352 has a temperature distribution such that the coldest points exist at the internal region of the internal electrode portions 220, thereby reducing or effectively preventing lamp quality from deteriorating due to exhaustion of effective mercury.

In addition, an UV radiation blocking layer may be formed on at least one of internal walls of the lamp tube 210, a body of the lamp tube 210, and outer walls of the lamp tube 210, and any combination thereof. The UV radiation blocking layer blocks the UV radiation emitted from the lamp 352, thereby reducing or effectively preventing deterioration of various backlight components, for example, the light guiding plate 360, the optical sheet 330, the reflector sheet 370, or the like.

The reflector 351 reflects light emitted radially from the lamp 352 in one direction, e.g. toward an incident surface of the light guide plate 360, so that an efficiency of light can be maximized.

The light guiding plate 360 converts the light having an optical distribution in the form of a line light source such as lamp unit 350, into a surface light source. In exemplary embodiments, the light guiding plate 360 can be a wedge-type plate or a substantially flat (e.g., planar) plate made of a transparent material having predetermined light reflectivity, for example, acryl resin such as PMMA (poly methy methacrylate), polyolefin, or polycarbonate.

The optical sheet 330 is disposed on the light guide plate 360 to allow brightness distribution of the light emitted from the light guide plate 360 to be substantially uniform. The optical sheet 330 may include, but are not limited to, a diffusion sheet 331, a first prism sheet 332, and a second prism sheet 333, which may be stacked sequentially from a bottom of the LCD towards the front. In exemplary embodiments, the diffusion sheet 331 may include diffusion patterns on its surface or interior portion, and scatters and diffuses upwardly the incident light from the light guiding plate 360. The first and second prism sheets 332 and 333, which may include prism patterns formed in a direction perpendicular to their top surfaces, respectively, convert the light entering with angles out of the light incident from the diffusion sheet 331 into the light in a vertical direction, and condense the light emitted upward.

The reflector sheet 370 is disposed below the light guiding plate 360, and reflects the emitted light upward, thereby maximizing light utilization efficiency. Uniform brightness through the exit surface of the backlight unit 410 can be achieved by controlling the reflected amount of the overall incident light by area. As shown, the reflector sheet 370 may be constructed in the form of a flat plate. The reflector sheet 370 may also be constructed to have an irregular shape having a predetermined reference reflecting surface, and triangular protrusions projecting from the reference reflecting surface. The reflector sheet 370 may be separately constructed from other components of the LCD to then be subsequently installed on a bottom surface of the bottom chassis 380. Alternatively, a reflective material may be directly coated on the bottom surface of the bottom chassis 380, or the bottom chassis 380 itself may be made of a reflective material. In this construction, the reflector sheet 370 may not be separately provided and may instead be included as an inseparable part of the bottom chassis 380, such as to form a single, continuous and indivisible bottom chassis 380 member.

The top chassis 310 includes a plane portion in which an opening portion is defined, and side wall portions bent downwardly at edges of the top chassis 310. The top chassis 310 is substantially shaped of a frame, in which a display area of the LCD panel 320 is exposed through the opening portion. The bottom chassis 380 includes a bottom surface on which the backlight unit 410 is seated, and side wall portions bent upwardly at edges of the bottom chassis 380. The bottom chassis 380 is shaped of a box having an open top surface so as to provide an accommodation space of a predetermined depth. The LCD panel 320 and the backlight unit 410 are accommodated in the accommodation space provided by combining the top chassis 310 and the bottom chassis 380 with each other. Meanwhile, a mold frame 340 surrounding edges of the LCD panel 320 to protect the LCD panel 320, and fixing the optical sheet 330 and the light guiding plate 360, are also accommodated in the accommodation space.

Alternatively, the lamps according to the present invention can be used as the light sources of a variety of products, and are not limited to the exemplary LCD devices.

Next, a liquid crystal display (LCD) including a lamp used as a direct-type backlight unit according to a fourth embodiment of the present invention will be described. Here, the same explanations as the previous embodiment will not be made or will be briefly made.

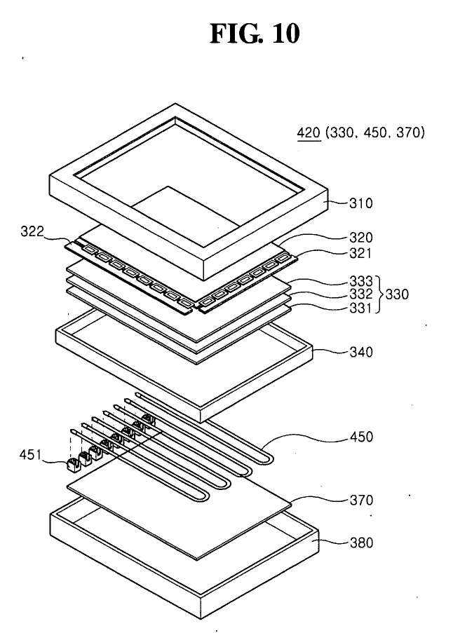

FIG. 10 is an exploded perspective view of another exemplary embodiment of a liquid crystal display according to the present invention.

Referring to FIG. 10, the LCD includes an LCD panel 320 displaying images, a backlight unit 420 disposed below the LCD panel 320, and a top chassis 310 and a bottom chassis 380 receiving the LCD panel 320 and the backlight unit 420.

The backlight unit 420 is disposed in rear of the LCD panel 320. In the illustrated embodiment of FIG. 10, the backlight unit 420 includes a lamp unit 450 emitting light, an optical sheet 330 disposed above the lamp unit 450, and a reflector sheet 370 disposed below the lamp unit 450.

The lamp unit 450 includes a plurality of lamps generating light. The U-shaped lamps according to FIGS. 4 and 5 can be used as the lamps. As shown in FIGS. 4 and 10, each of the lamps includes transparent caps 240 formed on outer surfaces completely around opposite (e.g., distal) ends of the lamp tube 210. The outer surfaces of the opposite ends of the lamp tube 210 are fitted into a lamp socket 451 fixed to the reflector sheet 370 and/or the bottom chassis 380. The transparent caps 240 preferably extend from a distal end of the lamp and toward the center of the lamp tube 210, so as to extend beyond inner ends of the internal electrode portions 220. The transparent caps 240 are disposed to cover at least a portion of the internal region of the internal electrode portions 220. In an exemplary embodiment, the transparent caps 240 are preferably made of a material having lower thermal conductivity than the lamp socket 451. The lamp has a temperature distribution such that the coldest points exist at the internal region of the internal electrode portions 220, thereby reducing or effectively preventing lamp quality from deteriorating due to exhaustion of effective mercury.

Power supply means (not shown), e.g., an inverter, connected to the lamp socket 451 for supplying lamp driving power to the lamp socket 451 may be provided below and/or external to the bottom chassis 380. The inverter changes externally applied low-potential AC power into high-potential AC power suitable to drive a lamp and supplies the same to each lamp.

In the exemplary embodiments of the present invention, transparent caps disposed covering at least portions of internal and external regions of internal electrode portions are provided on outer surfaces around opposite ends of a lamp tube, so that the coldest points of a lamp are formed in the internal region of the internal electrode portions. Advantageously, it is possible to prevent gathering of mercury due to formation of the coldest points at the external region of the internal electrode portions, thereby preventing lamp quality from deteriorating due to exhaustion of effective mercury even after prolonged use of the lamp.

In the exemplary embodiments of the present invention, since the coldest points are observed throughout a relatively wide area in the effective emissive area of the lamp, gathering of mercury (Hg) at local areas does not occur. Advantageously, since dark regions are not generated at a particular region of the effective emissive area, substantially uniform emission characteristics can be maintained over the entire effective emissive area.

Further, since the emission characteristics of the lamp of the exemplary embodiments can be maintained at a substantially uniform level over the entire effective emissive area, the display quality of an LCD can be further enhanced. In addition, since the emitting life cycle of the lamp is extended, the display quality of the LCD can be maintained in a more stable manner.

Moreover, in the exemplary embodiments, an ultraviolet light blocking layer for reducing or effectively preventing transparent caps from deteriorating due to UV radiation generated from a lamp, is provided on outer walls of a lamp tube and/or internal walls of transparent caps, thereby reducing or effectively preventing lamp quality from deteriorating even after prolonged use of the lamp.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A lamp comprising:
a lamp tube into which a discharge gas is injected;
an internal electrode portion disposed at each of a first end and a second end at an inner side of the lamp tube;
an electrode lead connected to each internal electrode portion, and extending to an exterior of the lamp tube; and
a transparent cap disposed on an outer surface of each of the first end and the second end of the lamp tube.

2. The lamp of claim 1, wherein each of the transparent caps extends toward a center of the lamp tube, and beyond inner ends of the internal electrode portions.

3. The lamp of claim 2, wherein each of the transparent caps extends to overlap an area of the lamp tube having a substantially uniform temperature distribution at an internal region of the internal electrode portions, the internal region of the internal electrode portions being a portion of the lamp tube between a point substantially corresponding to the inner ends of the internal electrode portions, and extending to a predetermined distance from the inner ends of the internal electrode portions.

4. The lamp of claim 2, wherein each of the transparent caps extends about 40 millimeters (mm) from a distal end of the lamp tube.

5. The lamp of claim 1, wherein the transparent caps include a material containing transparent polymer.

6. The lamp of claim 5, wherein the transparent polymer comprises at least one of vinyl, polyethylene terephthalate (PET), and polyvinyl chloride (PVC).

7. The lamp of claim 1, wherein the discharge gas comprises mercury.

8. The lamp of claim 1, further comprising an ultraviolet (UV) radiation blocking layer disposed on at least one of internal walls of the lamp tube, a body of the lamp tube, and outer walls of the lamp tube.

9. The lamp of claim 8, wherein the ultraviolet (UV) radiation blocking layer is disposed between the lamp tube and the transparent caps, both the ultraviolet (UV) radiation blocking layer and the transparent caps extending from a distal end of the lamp tube and ending at a predetermined distance from the distal end, and ends of the ultraviolet (UV) radiation blocking layer and the transparent caps substantially coincide with each other.

10. The lamp of claim 8, wherein the UV radiation blocking layer is made of titanium oxide.

11. A liquid crystal display (“LCD”) comprising:
an LCD panel displaying images; and
a backlight unit comprising at least one lamp providing light to the LCD panel,
wherein the at least one lamp comprises:
a lamp tube into which a discharge gas is injected, the lamp tube including a first distal end and a second distal end opposite to the first distal end;
an internal electrode portion disposed at each of the first distal end and the second distal end, and disposed at an inner side of the lamp tube,
an electrode lead connected to each of the internal electrode portions, and extending to an exterior side of the lamp tube, and
a transparent cap disposed on an outer surface of each of the first distal end and the second distal end of the lamp tube.

12. The LCD of claim 11, wherein each of the transparent caps extends toward the center of the lamp tube from the respective distal end, and ends of the transparent caps are disposed beyond inner ends of the internal electrode portions.

13. The LCD of claim 12, wherein the ends of the transparent caps are disposed overlapping an area of the lamp having a uniform temperature distribution at an internal region of the internal electrode portions, the internal region of the electrode portions being disposed beyond the inner ends of the internal electrode portions.

14. The LCD of claim 11, further comprising an UV radiation blocking layer disposed on at least one of internal walls of the lamp tube, a body of the lamp tube, and outer walls of the lamp tube.

15. The LCD of claim 14, wherein the UV radiation blocking layer is made of titanium oxide.

16. The LCD of claim 14, further comprising an ultraviolet (UV) radiation blocking layer disposed between the lamp tube and the transparent caps, both the ultraviolet (UV) radiation blocking layer and the transparent caps respectively extending from the first and the second distal ends of the lamp tube and ending at a predetermined distance from the first distal end and the second distal end, ends of the ultraviolet (UV) radiation blocking layer and the transparent caps substantially coinciding with each other.

17. The LCD of claim 11, further comprising a mounting member fixing the lamp.

18. The LCD of claim 17, wherein the transparent caps are made of a material having lower thermal conductivity than the mounting member.

19. The LCD of claim 17, wherein the lamp is installed on either a lateral surface, or an entire area of a rear surface of the LCD panel.
